(19) United States
(12) Patent Application Publication
(10) Pub. No.: US 2006/0202149 A1
(43) Pub. Date: Sep. 14, 2006

(54) Cylindrical plug valve

(76) Inventor: G. Robert Muddiman, Oakville (CA)

Correspondence Address: IAN FINCHAM, SUITE 606, 225 METCALFE STREET, OTTAWA, ON, K2P 1P9, CA

(21) Appl. No.: 11/431,859

(22) Filed: May 11, 2006

(30) Foreign Application Priority Data
Nov. 12, 2004 (WO) PCT/CA04/01955
Nov. 14, 2003 (CA) 2,449,372

(51) Int. Cl. F16K 5/00

(52) U.S. Cl. 251/309

(57) ABSTRACT

A plug valve has a body with inlet and outlet ports with a cylindrical chamber therebetween for receiving a cylindrical plug. The body includes a circumferential resilient seat ring around the outlet port The cylindrical plug includes a generally horizontal “U” shaped transaxially cut-out portion which aligns with the inlet and outlet ports when in the open position, where the cross section opposite the cut-out portion is the shape of a segment of a circle. When the plug is rotated to the closed position, the segment covers the outlet port and the circumferential resilient seat. The plug includes a generally rectangular slot across the top surface of the plug at right angles to the segment. The plug is rotated by a separate stem which has a corresponding end to that of the slot. In the closed posidon, the plug is able to move relative to the stem in the direction of flow. Thus, the upstream pressure will force the plug into the seat causing the seal to become tighter as the pressure rises.

### FIELD OF THE INVENTION

This invention relates to a plug valve, more particularly, to a cylindrical plug valve including a separate operating stem.

### BACKGROUND OF THE INVENTION

In prior art plug valve designs, the operating stem is an integral part of the plug whereby the stem and plug are one piece. Consequently, the plug cannot move relative to the stem.

In prior art plug valve designs, there is a fluid passageway through the plug from one side to the other. Consequently, when partially open, the flow path between the inlet and outlet ports is tortuous causing undesired increased turbulence. The flow must first pass through the opening between the inlet port and the entrance to the passageway of the plug, immediately change directions for flow through the passageway, then change direction again to exit the passageway and flow into the outlet port.

In the prior art, plug valve designs teach sealing by either (1) making the plug tapered for fitting into a matching tapered cavity in the body (sealing is achieved by forcing the plug deeper into the body); (2), by filling the space between the surface of the plug and the bore of the body with thick lubricant; or (3) by making the center of rotation of the plug eccentric to the center of the bore of the body so that as the plug rotates, the face moves closer to the seat.

In the present invention, the plug and stem are separate parts connected by means of a slot across the top of the plug transverse to the transaxially cut out portion of the plug. Consequently, the plug is able to move relative to the stem in the direction of the slot. As a result, when in the closed position, the upstream pressure can move the plug forward against the downstream seat, thus providing a tighter seal which increases as the pressure rises. In the present invention and in one embodiment, there is no passageway through the plug. Instead, there is a transaxially cut out portion of the plug so the fluid flow can move straight through the valve without changing directions. In the present invention, sealing is achieved by having the blind face of the plug bear on a resilient seating material when in the closed position.

### SUMMARY OF THE INVENTION

According to one aspect of the present invention is to provide a plug valve assembly comprising an improved plug design in combination with a separate operating stem with a seal surrounding the downstream port of the valve body.

According to another aspect, there is provided a plug valve comprising a valve body having an opposed inlet and outlet and a chamber therebetween, a closing member rotatably mounted within the chamber adapted to control fluid flow through the valve, the closing member including a transaxially cut-out portion, a valve stem slidably coupled to the upper surface of the plug valve, and at least one seal disposed about the outlet for preventing fluid leakage therealong.

A plug valve comprising a valve body having an opposed inlet and outlet, with a cylindrical chamber therebetween in communication therewith, and a cylindrical plug rotatably mounted within the chamber adapted to control fluid flow, the plug having opposed upper and lower surfaces and a transaxially cut-out portion between the upper and lower surfaces, the upper surface of the plug having stem receiving means extending generally transversely to the transaxially cut-out portion of the plug, a valve stem releasably engageable with a stem engaging means of the upper surface of the plug to effect rotation of the plug between a first open position defined when the plug permits fluid flow between the inlet and the outlet, and a second closed position defined when the plug prevents fluid flow between the inlet and outlet, the valve stem being slidably engaged in the stem receiving means to permit relative movement of the plug with respect to the valve stem when the plug is in the closed position; and at least one seal circumferentially disposed about the outlet for preventing fluid leakage, whereby the relative movement of the plug in the chamber with respect to the valve stem occurs upon fluid pressure acting on the plug to thereby urge the plug into increased sealing contact with the seal means.

According to another aspect, a plug valve as noted above, wherein the inlet and outlet are positioned 180° apart, and wherein the body includes an opening at a lower portion thereof to permit the plug to be inserted therein.

According to any of the above embodiments,.wherein the valve body further includes an opening through an upper portion thereof, the opening adapted to permit the operating stem to be inserted therein.

A plug valve according to any of the above, wherein the plug is of a diameter generally corresponding to that of the chamber in the valve body.

According to another aspect of the plug valve of the present invention, a plug valve according to any of the above embodiments wherein the stem receiving means is a generally rectangular slot on an upper surface of the plug, the slot being in a direction 90° to the transversely cut out portion side of plug, and where the valve stem preferably includes at one end thereof a generally flat portion dimensioned to fit into the slot, and further wherein the stem includes connection means on an end opposite the flat portion, the connection means adapted to receive stem control means for rotating the stem.

According to another aspect of the present invention as noted above, the valve body includes a base plate adapted to support the plug and to close the opening at the lower portion of the body, the plate including means to secure the plate to the valve body.

A plug valve according to any of the above aspects, wherein the seal is manufactured from a resilient material, the seal being dimensioned to fit in a groove in the body located around the outlet, and is preferably made of poly tetra-fluro-ethylene.

### BRIEF DESCRIPTION OF THE DRAWINGS

Further aspects and advantages will become apparent from the following detailed description according to preferred embodiments with reference to the drawings;

FIG. 1 is a top down view illustrating a valve body of the present invention;

FIG. 2 is a cross-sectional side view taken along lines a-a of the valve body in FIG. 1, illustrating the valve chamber and seal;

FIG. 3 is a rear elevational view of the plug of the present invention;

FIG. 3a is a section taken along lines b-b of FIG. 3;

FIG. 3b is a rear side view of FIG. 3;

FIG. 4 is a front elevational view of the plug depicting the cut out cavity;

FIG. 5 is a side view of the base plate;

FIG. 5a is a bottom view of FIG. 5;

FIG. 6 is a front view of the resilient seat ring;

FIG. 6a is a cross-sectional side view taken along lines C-C;

FIG. 7 is a side view of the operating stem;

FIG. 7a is a top down view of the stem of FIG. 7;

FIG. 7b is a bottom up view of the stem of FIG. 7;

FIG. 8 is a top down cross sectional view of a plug valve of the prior art illustrating the flow-in a partially open position within a plug valve body;

FIG. 9 is a top down cross sectional view of a plug valve of the present invention illustrating the flow in a partially opened position within the plug valve body, and

FIG. 10 is a top down, cross-sectional view of the present invention showing the position of the plug segment in the fully closed position, with the dotted line showing the position of the plug segment when in the full open position.

### DESCRIPTION OF THE PREFERRED EMBODIMENTS

With reference to the accompanying Figures, a plug valve according to a preferred embodiment of the present invention is generally illustrated as reference numeral 10. The plug valve 10 includes a valve body or housing 20, a cylindrical plug or segment plug 50 and an operating stem 100. The valve body or housing 20 is adapted to receive the plug 50 therein. A resilient seat or sealing member 110 is provided at a downstream end of the valve housing 20 thereof to prevent leakage. As will be understood by those skilled in the art to which the present invention pertains, the plug valve 10 may be used in conjunction with various sources of fluid pressure, such as liquids, gas, slurries, etc.

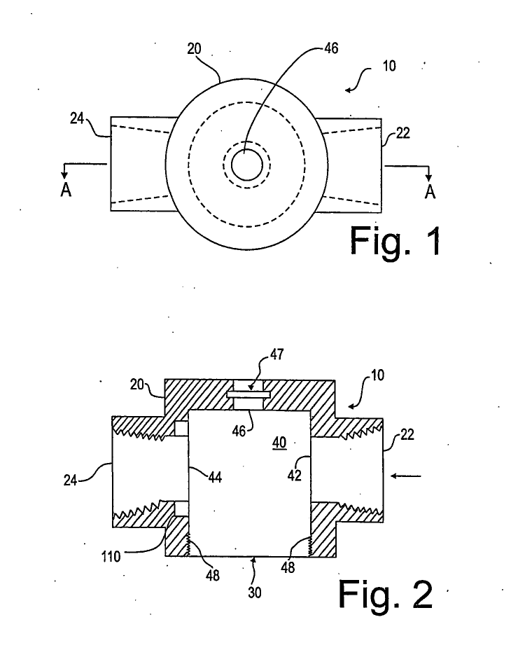

As illustrated in FIGS. 1 and 2, housing or body member 20 includes a bottom opening 30, the valve body 20 being generally cylindrical in overall configuration having an inlet port 22 and outlet port 24 in opposed relationship at either end of the housing. Inlet and outlet 22 and 24, respectively, are adapted to be suitably connected to upstream and downstream conduits, and as illustrated inlet and outlet 22 and 24 are desirably located in a horizontally opposed relationship, i.e. 180° from each other, when viewed from the side or the top perspective.

As illustrated in FIG. 2, housing or body member 20 includes a generally cylindrical valve chamber 40, including an interior upstream end 42 and an interior downstream end 44, and is adapted to receive a cylindrical plug 50 therein. A generally horizontal, transverse bore (described hereinafter) through the plug 50 connects inlet and outlet ports 22 and 24 to create a flow passage through the valve body 20 when aligned with the ports in various open conditions of the plug 50.

At the upper or top portion of the chamber 40 is a generally vertical bore 46, which is adapted to receive at least a portion of the operating stem 100 therein. Bore 46 includes a circumferential groove 47 for a sealing ring member, such as an “O” ring or the like (not shown), which cooperates with the stem 100 to prevent fluid escaping from around the operating stem 100 when in use.

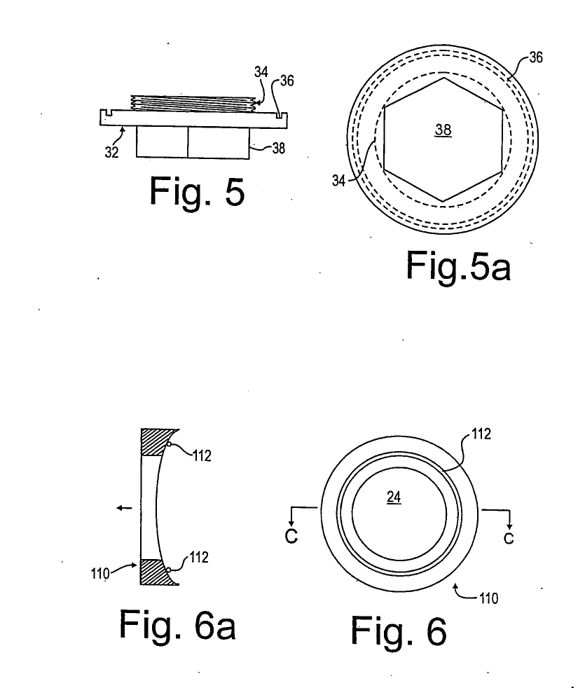

When viewed from a side perspective, as illustrated in FIG. 2, the opening 30 located at the lower or bottom end of the valve chamber 40 includes connection means 48 in the form of a straight thread or the like proximate the sides of the opening 30 to connect or otherwise secure the valve body 20 to a base plate 32. As illustrated in FIGS. 5 and 5a, base plate 32 includes a corresponding straight thread 34, a circumferential groove 37 for receiving therein a seal, and a tightening member 38, such as a wrench pad or the like, for connecting the base plate to the valve body 20. Opening 30 is of a sufficient diameter or dimension for permitting plug 50 to be installed therethrough, after which the base plate 32 is connected or secured to the body 20, via, for example, mating portion 34.

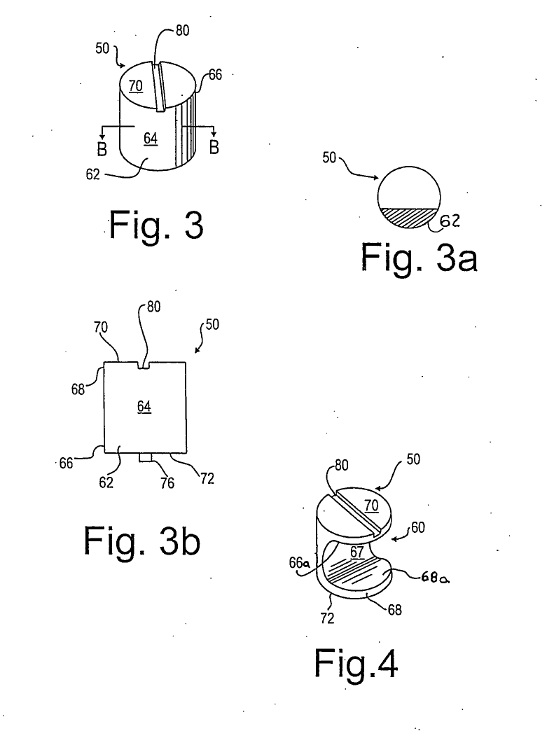

Rotatably mounted within the valve chamber 40 is a plug member 50. The cut out portion of which aligns with the inlet and outlet ports when in an open position and closes the outlet port when the blind side or segment portion covers the outlet port. Plug 50 has an overall exterior configuration, as illustrated in FIGS. 3, 3a, 3b and 4, of a cylindrical shape when viewed from a side perspective. The exterior surface of plug 50 has an overall generally uniform diameter, and is slightly smaller in diameter than the diameter of the cavity member 40, to enable the plug 50 to be slidably fitted into the body cavity 40.

Plug 50 includes on one side thereof a generally horizontally “U” shaped, transaxially cut out, cross-flow cavity 60 which is registerable with the inlet and outlet ports to permit flow in the open position. The opposite side of the segment plug 50 is generally in the shape of a segment of a circle when viewed in cross section from the top and has a generally arcuate sidewall 62, defining part of the generally cylindrical profile of the segment plug 50.

According to one embodiment of the present invention, and as illustrated in the FIGS. 3, 3a, 3b and 4, the plug or segment plug 50 may be manufactured from a round bar to have a generally cylindrical configuration. The base plate 32 when in use is adapted to close the opening 30 through the bottom of the body 20 and support the plug 50 with means to secure it to the body, the plug 50 having on one side thereof a cross flow cavity 60 extending therethrough that aligns with the inlet and outlet ports of the body when in an open position, and adapted to be aligned with or disposed at right angles to the flow passage.

Sidewall 62 has an outwardly facing, arcuate exterior wall surface 64, and a pair of generally curved interior upper and lower walls 66 and 68 interconnected by sidewall 62. The upper and lower exterior surfaces 70 and 72 respectively, of said plug 50 are generally flat.

Upper surface 70 includes a slot or groove 80, to receive a mating portion on one end of the stem 100. As illustrated, the slot 80 cuts across the top of the plug 50 from one side to the other substantially at right angles to the segment portion of the plug 50.

As illustrated in FIG. 3b, on the lower surface 72 of the plug 50, there is a reduced diameter extension 76 which rests on the base plate 32, that reduces the area of the plug that bears on the baseplate, thus reducing friction when the plug rotates or moves downstream. Attentively, a Teflon disc or the like may be placed between extension 76 and base plate 32 to help reduce friction therebetween.

As illustrated, the cross-flow cavity 60 of the plug includes a vertical axis extending through the body of the segment plug 50 in a direction transverse to the axis of rotation. The sides of the cavity 60 of the plug are defined by opposite interior flat surfaces 66a and 68a of the top and bottom walls 66 and 68, such that interior surfaces 66a and 68a extend generally parallel to one another in the plug to a point slightly beyond the central point of the axis of rotation (FIG. 4). The surfaces 66a and 68a, join interiorly together to form an arcuately concave interior surface 67 of the plug. This is advantageous in that a pipe cleaning device, commonly known in the industry as a “pig”, is able to pass through the valve 10 without difficulty.

As illustrated, the sidewall 62 corresponds dimensionally to the passage such that at all points between the full, open position and the full, closed position of the segment plug 50 do not obstruct flow in the valve once flow has commenced.

According to a preferred embodiment, the segment plug 50 is preferably constructed from a material similar to that used for the valve body 20 so that both of those components expand and contract to the same extent when subjected to high or low temperatures.

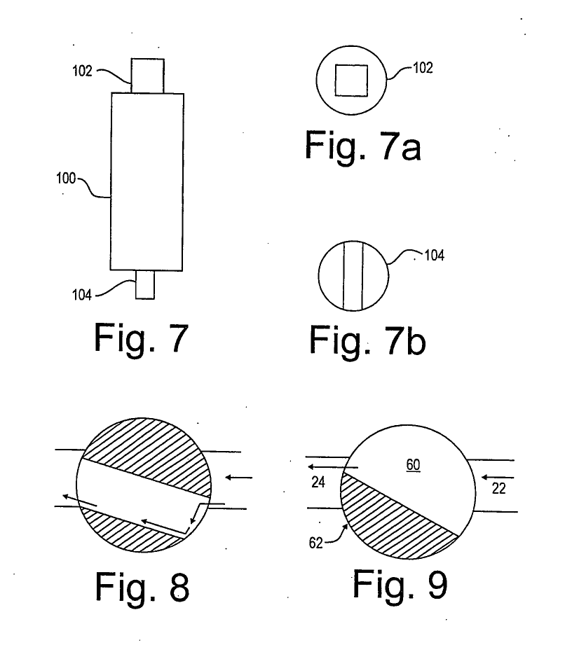

The operating stem 100 is positioned with the valve body 10 such that the stem is in operative association with the plug 50 to facilitate rotational movement of the plug 50 between open and closed positions in a conventional manner. As illustrated in FIGS. 7, 7a and 7b, operating stem 100 includes opposed ends 102 and 104, end 102 being adapted to connect to a lever handle or other handle assembly known in the art attached to the end of the operating stem 100 thereof to facilitate rotation by a user. End 104 is dimensioned or so configured to fit or couple with the slot 80 of the plug 50, for rotating the plug between open and closed positions.

As illustrated in FIGS. 2, 6 and 6a, there is provided a resiliently deformable sealing member or seat ring is provided, circumferentially extending about the interior of the body 20 around the downstream port 44 of the body 20. Resilient seal or seat ring 110 is located around the outlet port or downstream end 44 of the body 20. As illustrated in FIG. 6a, the seat ring 110 may include, or be replaced by, a raised bead 112 or similar projection extending therefrom for contact with the plug 50. When the plug 50 is in a closed or second position, the resilient seat 110 is compressed between the side wall 62 and an interior surface of the bore around the passage for sealed contact therebetween.

In use, the circumferential sealing member 110 positioned between the plug 50 and the downstream passage prevents fluid from escaping from the interior of the plug valve. A similar sealing member is also provided between the stem 100 and the interior of the plug valve, as noted herein above.

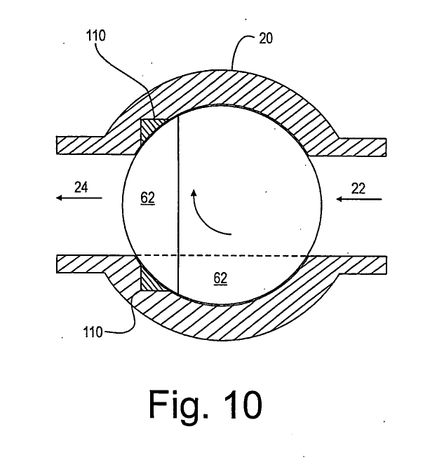

As illustrated in FIGS. 9 and 10, the segment plug 50 is rotatably housed within the valve body 20 such that the segment plug 50 is adapted to permit opening and closing of the inlet and outlet ports 22 and 24, by rotating between first and second positions. To interconnect the inlet and outlet ports 22 and 24, plug 50 is rotated and creates a flow passage through the valve chamber 40 via the cavity 60. The opening or closing of the flow passage depends upon the position of the valve stem 100 which actuates the segment plug 50. The segment plug 50 is able to rotate through 90° of rotation between its open position illustrated in dashed lines in FIG. 10, and its closed position as illustrated in solid lines in FIG. 10, by movement of the operating stem 100. The point of juncture between the plug 50 and the stem 100 is formed at one end thereof with a slot or other similarly shaped operating end 104 for engagement with the corresponding slot 80, whereupon actuation or rotation of the stem 100 the plug or segment plug 50 moves downstream into the resilient seat or sealing member 42.

When the segment plug 50 is in its fully open position, the opposite ends of the cavity 60 are aligned with the inlet and outlet ports 22 and 24 to permit fluid or gaseous material to flow within the created flow passage. The sidewall 62 is generally disposed along one side of the passage 30 when the plug 50 is in an aligned or opened position. When the segment plug 50 is in its closed position as illustrated in solid lines in FIG. 10, the cavity 60 extends transverse to the passage with the segment or sidewall 62 at the upstream end of chamber 40 covering the outlet and the resilient seat around it 60 and spanning the passage 30 so as to close passage 30.

In such a closed position, the plug 50 is able to move relative to the stem in the direction of the flow. Desirably, the slot 80 of the plug 50 will permit the plug 50, when under upstream pressure, to move axially relative to the stem 100. Thus, the upstream pressure will force the plug 50 into the resilient seat 110 to become tighter as the pressure increases. Preferably, the axial movement of the stem and plug will be in the range of a few millimeters. For examplary purposes only, such axial movement may be in the range of 0.25 to 2 millimeters, and other values may be realized dependent upon final construction and desirable characteristics. When the segment plug 50 is in a partially closed position as illustrated in FIG. 9, at least a portion of the cavity 60 is still partially aligned with the inlet and outlet 22 and 24 to permit partial flow through the valve body 20. The sidewall 62 is partially across the upstream end of the chamber 40, thus providing an absence of obstructing surfaces to the flow once it has entered the upper end of the cavity 60, as illustrated in FIG. 8 which represents a typical ball valve or prior art plug valve having a center passageway.

Although preferred embodiments of the invention have been described above, it is not limited thereto and it will be apparent to those skilled in the art that numerous modifications form part of the present invention insofar as they do not depart from the spirit or scope of the invention as defined in the accompanying claims.

1. A plug valve comprising:
a valve body having an opposed inlet and outlet, and a cylindrical chamber therebetween in communication with said inlet and said outlet,
a cylindrical plug rotatably mounted within said chamber adapted to control fluid flow, said plug having opposed upper and lower surfaces and a transaxially cut-out portion between said upper and lower surfaces;
said upper surface of said plug having stem receiving means extending generally transversely to said transaxially cut-out portion of said plug;
a valve stem releasably engageable with said stem engaging means of said upper surface of said plug to effect rotation of said plug between a first open position defined when said plug permits fluid flow between said inlet and said outlet and a second closed position defined when said plug prevents fluid flow between said inlet and outlet;
said valve stem being slidably engaged in said stem receiving means to permit relative movement of said plug with respect to said valve stem when said plug is in said closed position; and
at least one seal circumferentially disposed about the outlet for preventing fluid leakage,
whereby said relative movement of said plug in said chamber with
respect to said valve stem occurs upon fluid pressure acting on said plug to thereby urge said plug into increased sealing contact with said seal means.

2. A plug valve according to claim 1, wherein said inlet and outlet are positioned 180° apart.

3. A plug valve according to claim 1, wherein said body includes an opening at a lower portion thereof to permit said plug to be inserted therein.

4. A plug valve according to claim 1, wherein said valve body further includes an opening through an upper portion thereof, said opening adapted to permit said operating stem to be inserted therein.

5. A plug valve according to claim 1, wherein said plug is of a diameter generally corresponding to that of said chamber in said valve body.

6. A plug valve according to claim 1, wherein said stem receiving means is a generally rectangular slot on an upper surface of said plug, said slot being in a direction 90° to said transversely cut out portion side of said plug.

7. A plug valve according to claim 6, wherein said valve stem includes at one end thereof a generally flat portion dimensioned to fit into said slot.

8. A plug valve according to claim 7, wherein there is provided connection means on an end opposite said flat portion, said connections adapted to receive stem control means for rotating said stem.

9. A plug valve according to claim 3, wherein said valve body includes a base plate adapted to close said opening in said lower portion of said body, said plate including means to secure said plate to said valve body.

10. A plug valve according to claim 1, wherein said seat is manufactured from a resilient material, said seat being dimensioned to fit in a groove in said body located around said outlet.

11. A plug valve according to claim 10, wherein said resilient material is poly tetra-fluro-ethylene.

12. A plug valve according to claim 4, wherein said opening in said upper portion of said valve body includes a circumferential groove adapted to receive a resilient material seal therein.

13. A plug valve comprising:
a valve body having an opposed inlet and outlet, and a cylindrical chamber therebetween in communication with said inlet and said outlet,
a moveable cylindrical plug rotatably mounted within said chamber adapted to control fluid flow between said inlet and said outlet, said plug having opposed upper and lower surfaces and a transaxially cut-out portion between said upper and lower surfaces;
said upper surface of said plug having an elongated slot therein for receiving a valve stem, said slot extending generally transversely to said transaxially cut-out portion of said plug;
a valve stem having a projection moveably engageable with said elongated slot of said upper surface of said plug to effect rotation of said plug between a first open position defined when said plug permits fluid flow between said inlet and said outlet and a second closed position defined when said plug prevents fluid flow between said inlet and outlet;
said valve stem projection permitting slidable engagement in said slot to permit relative movement of said plug with respect to said valve stem when said plug is in said closed position; and
at least one seal circumferentially disposed about the outlet for preventing fluid leakage,
whereby said relative movement of said plug in said chamber with respect to said valve stem occurs upon fluid pressure acting on said plug to thereby urge said plug into increased sealing contact with said seal means.

14. (canceled)

15. A method for permitting relative movement in a plug valve between a separate valve stem and separate cylindrical plug, comprising:
providing a valve body having an opposed inlet and outlet, and a cylindrical chamber therebetween in communication with said inlet and said outlet,
providing a cylindrical plug rotatably mounted within said chamber adapted to control fluid flow, said plug having opposed upper and lower surfaces and a transaxially cut-out portion between said upper and lower surfaces;
providing in said upper surface of said plug stem receiving means extending generally transversely to said transaxially cut-out portion of said plug;
providing a valve stem releasably engaged with said stem engaging means of said upper surface of said plug to effect rotation of said plug between a first open position defined when said plug permits fluid flow between said inlet and said outlet and a second closed position defined when said plug prevents fluid flow between said inlet and outlet; said valve stem being slidably engaged in said stem receiving means to permit relative movement of said plug with respect to said valve stem when said plug is in said closed position; and
providing at least one seal circumferentially disposed about the outlet for preventing fluid leakage, and
whereby the mounting of said stem in said slot in a moveable relationship between said stem and said plug permits relative axial movement of said stem in said slot when in a closed position upon fluid pressure.

16. A plug valve according to claim 1, wherein said body includes an opening to permit said plug to be received into said chamber, and means for closing the opening.
